(19) United States
(12) Patent Application Publication
(10) Pub. No.: US 2008/0310658 A1
(43) Pub. Date: Dec. 18, 2008

(54) Headphone for Sound-Source Compensation and Sound-Image Positioning and Recovery

(76) Inventor: Hsin-Yuan Kuo, Kaohsiung County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/134,013

(22) Filed: Jun. 5, 2008

(30) Foreign Application Priority Data
Jun. 15, 2007 (TW) 96121760

(51) Int. Cl. H04R 5/033

(52) U.S. Cl. 381/310

(57) ABSTRACT

A headphone for sound-source compensation and sound-image positioning and recovery is provided, including a left speaker device for playing to a left ear of a user left channel sound and right channel sound originating from at least a sound signal, and a right speaker device for playing to a right ear of the user left channel sound and right channel sound originating from the sound signal. A user wearing the headphone of the invention perceives stereo sound field and sound image positioning seemingly provided by a loudspeaker.

### FIELD OF THE INVENTION

The present invention relates to headphones for sound-source compensation and sound-image positioning and recovery, and more particularly, to a headphone adapted for sound-source compensation and sound-image positioning and recovery and capable of generating sound by sound compensation such that the sound generated is characterized by sound field seemingly provided by a stereo loudspeaker.

### DESCRIPTION OF RELATED ART

Headphones are often used in daily life of people nowadays. Speaker of conventional headphones always abut against the user's ears. Referring to FIG. 1 and FIG. 2, which are top plan views of an earphone 1 and a circumaural headphone 2 respectively. Referring to FIG. 1 and FIG. 2, a speaker 3 of the earphone 1 or the circumaural headphone 2 abuts against the user's ear 4 while playing music and attempts to allow the music to reach the inside of the ear directly. The stereo synthesized and produced in the aforesaid manner is not genuine, because the stereo is developed in a way not found in reality. Referring to FIG. 3, which is a schematic view showing sounding of a conventional stereo loudspeaker, the stereo loudspeaker comprises a left channel loudspeaker 5 and a right channel loudspeaker 6. Once the stereo loudspeaker sounds, perception of sound from the left channel loudspeaker is not limited to the user's left ear, and perception of sound from the right channel loudspeaker is not limited to the user's right ear; in fact, both ears hear the sound from the left channel loudspeaker and the right channel loudspeaker. As shown in the drawing, the sound produced by the left channel loudspeaker 5 includes not only direct left channel sound 9 that reaches a left ear 8 of a user 7 but also indirect left channel sound 12 that reflects off a wall 10 and reaches a right ear 11 of the user 7; likewise, the sound produced by the right channel loudspeaker 6 includes not only direct right channel sound that reaches the right ear 11 of the user 7 but also indirect right channel sound that reaches the left ear 8 (not shown). Hence, the left ear 8 and the right ear 11 of the user 7 not only perceive direct left channel sound and direct right channel sound respectively, but also perceive indirect right channel sound and indirect left channel sound respectively, as rephrased as follows:

The left ear perceives: direct left channel sound of the left channel loudspeaker+indirect right channel sound of the right channel loudspeaker

The right ear perceives: direct right channel sound of the right channel loudspeaker+indirect left channel sound of the left channel loudspeaker

In fact, the above principle is true not only in listening to a stereo loudspeaker system but also in reality. All sounds are perceivable by the human ears by nature before being distinguished from one another in terms of locations of sound sources according to the position of the reception of the sounds and the difference in the time of the reception of the sounds. Hence, to be able to generate stereo sound field indeed, a headphone has to meet as much as possible the above conditions and method for sound propagation. At present, a conventional stereo headphone replays music in an unreasonable manner. A left speaker of a conventional stereo headphone is equivalent to the left channel loudspeaker 5 and therefore receives and plays left channel sound. A right speaker of a conventional stereo headphone is equivalent to the right channel loudspeaker 6 and therefore receives and plays right channel sound. However, the fact is that there is a big difference between a stereo headphone and a stereo loudspeaker in operation. Where a headphone system is in operation, the left ear perceives left channel sound (but could not hear right channel sound), and the right ear perceives right channel sound (but could not hear left channel sound). Where a loudspeaker system is in operation, both ears perceive the left and right channel sounds though not synchronously. In general, where the user 7 listens to the loudspeaker system with a setting positioned normally, the right ear 11 of the user 7 is definitely closer to the right channel loudspeaker 6, and the left ear 8 of the user 7 is definitely closer to the left channel loudspeaker 5 (as shown in FIG. 3). At the time, the left ear 8 of the user 7 can directly perceive a linear sound 9 from the left channel loudspeaker 5 without any difficulty, and the right ear 11 of the user 7 can directly perceive the linear sound 9 from the right channel loudspeaker 6 without any difficulty. However, with sound being capable of scattering and reflection, the sound from the left channel loudspeaker 5 indirectly reaches the right ear 11 of the user 7 by scattering and reflection (along a sound path 12 shown in FIG. 3) in the presence of obstacles, such as the head and the nose between the right ear 11 of the user 7 and the left channel loudspeaker 5. Since the sound from the left channel loudspeaker 5 does not reach the right ear 11 of the user 7 directly and the right ear 11 of the user 7 is farther than the left ear 8 of the user 7, the right ear 11 of the user 7 differs slightly from the left ear 8 of the user 7 in perceiving the intensity and arrival time of the sound from the left channel loudspeaker 5 (with the same phenomenon but in an opposite direction in perceiving the sound from the right channel loudspeaker 6, and the related description is herein omitted for the sake of brevity). As revealed by our listening experience and the position of a microphone in a live recording scenario, the aforesaid two-channel loudspeaker system is capable of reproducing high-fidelity stereo effects.

However, this is not the case in listening to a headphone. While the headphone system is in operation, left channel sound from the left speaker is perceived by the left ear only, and right channel sound from the right speaker is perceived by the right ear only. However, in reality no natural sound enters the left ear and the right ear via a left channel and a right channel separately and respectively! Hence, owing to the way of playing conventional headphones, original sound inevitably undergoes bilateral separation, and thus sound images are hardly stable (but shift bilaterally). Not only does stereo positioning suffers loss of fidelity, but users of conventional headphones get tired and uncomfortable after long use of the conventional headphones (as, at a subconscious level, the brain continuously tries to position sound sources and sound images in vain, and thus fatigue is exacerbated over time).

Accordingly, a problem that calls for immediate solution and to be solved by the present invention involves providing a headphone adapted for double-stereo-sound-source positioning and recovery and implemented by sound delay so as to create a natural impression of sound heard from various directions as in natural hearing.

### SUMMARY OF THE INVENTION

In view of the aforesaid drawbacks of the prior art, the inventor of the present invention realized the room for improvement of the prior art. Hence, the inventor endeavored to devise a headphone adapted for double-stereo-sound-source positioning and recovery and implemented by sound delay so as to create a natural impression of sound heard from various directions as in natural hearing, based on the inventor's expertise and years of practical experience.

With the aforesaid objective in mind, the present invention provides a headphone for sound-source compensation and sound-image positioning and recovery, comprising a left speaker device for playing to a left ear of a user left channel sound and right channel sound originating from at least a sound signal, and a right speaker device for playing to a right ear of the user left channel sound and right channel sound originating from the sound signal.

Accordingly, with sound compensation, the headphone for sound-source compensation and sound-image positioning and recovery of the present invention creates a natural impression of sound heard from various directions as in natural hearing.

### BRIEF DESCRIPTION OF DRAWINGS

FIG. 1 is a top plan view of a conventional earphone;

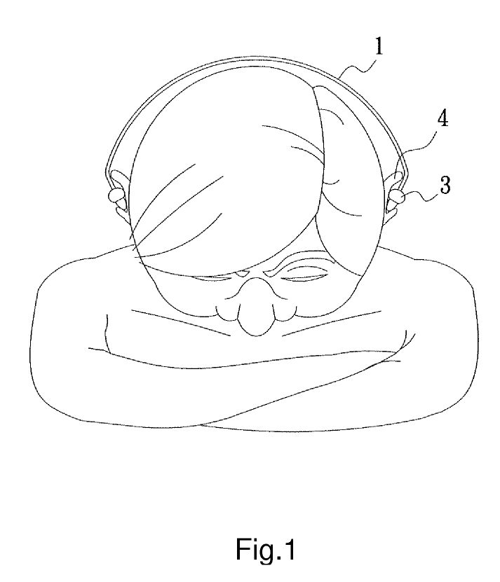

FIG. 2 is a top plan view of a conventional circumaural headphone;

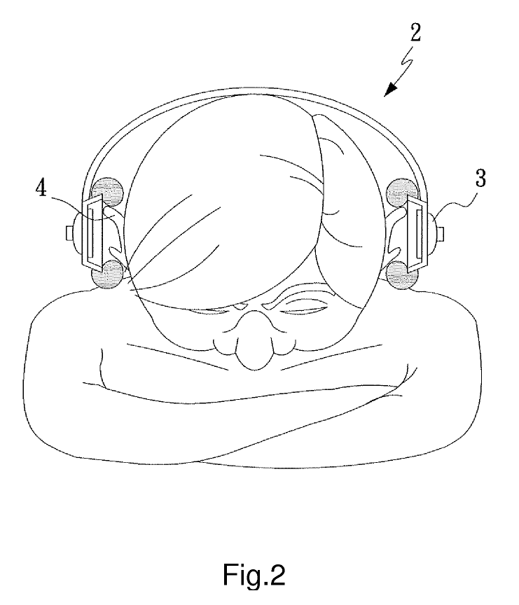

FIG. 3 is a schematic view showing sounding of a conventional stereo loudspeaker;

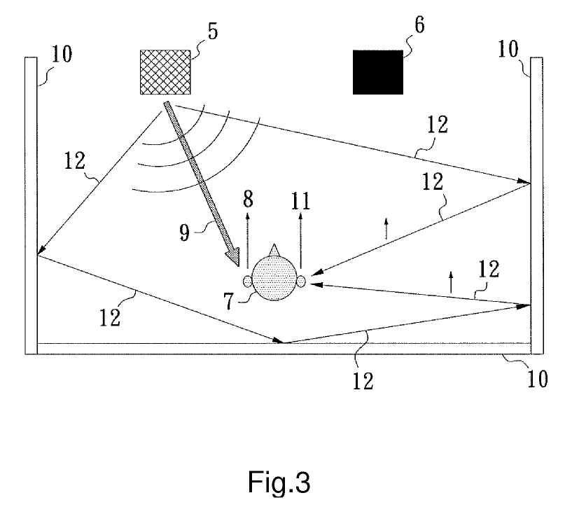

FIG. 4 is a schematic view showing a preferred embodiment of a headphone for sound-source compensation and sound-image positioning and recovery according to the present invention; and

FIG. 5 is a schematic view showing a preferred embodiment of a user wearing a headphone for sound-source compensation and sound-image positioning and recovery according to the present invention.

### DETAILED DESCRIPTION OF PREFERRED EMBODIMENTS

The present invention is herein illustrated with a specific embodiment and the accompanying drawings, so that one skilled in the pertinent art can easily understand objectives, features, other advantages and effects of the present invention from the following disclosure of the invention.

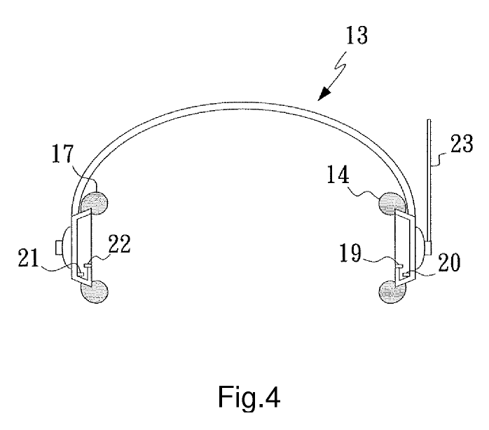

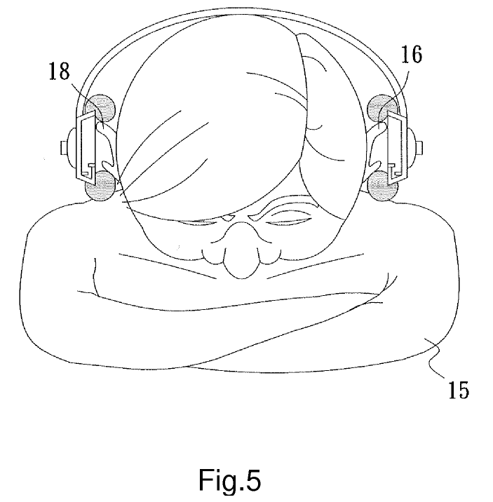

Referring to FIG. 4 and FIG. 5, which is a schematic view showing a preferred embodiment of a headphone for sound-source compensation and sound-image positioning and recovery according to the present invention and a schematic view showing a preferred embodiment of a user wearing a headphone for sound-source compensation and sound-image positioning and recovery according to the present invention respectively, as disclosed in the present invention. Referring to FIG. 4 and FIG. 5 simultaneously, a headphone for sound-source compensation and sound-image positioning and recovery 13 comprises a left speaker device 14 (comprising a first left speaker 19 and a first right speaker 20 in the present preferred embodiment, though the left speaker device 14 may comprise only one speaker or a plurality of speakers as well) for playing to a left ear 16 of a user 15 left channel sound and right channel sound originating from at least a sound signal, and a right speaker device 17 (comprising a second left speaker 21 and a second right speaker 22 in the present preferred embodiment, though the right speaker device 17 may comprise only one speaker or a plurality of speakers as well) for playing to a right ear 18 of the user 15 left channel sound and right channel sound originating from the sound signal. Right channel sound generated by the first right speaker 20 is slightly later or slightly weaker than left channel sound generated by the first left speaker 19. Left channel sound generated by the second left speaker 21 is slightly later or slightly weaker than right channel sound generated by the second right speaker 22. The headphone for sound-source compensation and sound-image positioning and recovery 13 further comprises a signal input device 23 (such as a wired signal input device or a wireless signal input device) for inputting the sound signal to the headphone for sound-source compensation and sound-image positioning and recovery 13. Depending on the need of the user 15, the headphone for sound-source compensation and sound-image positioning and recovery 13 further comprises a power device (such as a battery, though not limited thereto) for supplying the headphone with power required. Or the headphone for sound-source compensation and sound-image positioning and recovery 13 further comprises a sound control device (not shown) for adjusting timbre or volume of the headphone for sound-source compensation and sound-image positioning and recovery 13.

As revealed by the above description, the present invention provides a headphone adapted for sound-source compensation and sound-image positioning and recovery and implemented by sound delay so as to create a natural impression of sound heard from various directions as in natural hearing. Hence, from a patent perspective, the present invention has novelty, improvement, and high industrial applicability, which is suitable to be granted a patent.

The foregoing disclosure is described in detail. However, it is only the preferred embodiment of the application but is not intended to restrict the scope of the present invention. It is apparent to those skilled in the art that all equivalent modifications and variations made in the foregoing embodiment according to the spirit and principle in the disclosure of the present invention should fall within the scope of the appended claims.

What is claimed is:

1. A headphone for sound-source compensation and sound-image positioning and recovery, comprising:
a left speaker device for playing to a left ear of a user left channel sound and right channel sound originating from at least a sound signal; and
a right speaker device for playing to a right ear of the user left channel sound and right channel sound originating from the sound signal.

2. The headphone for sound-source compensation and sound-image positioning and recovery of claim 1, further comprising a signal input device for inputting the sound signal to the headphone for sound-source compensation and sound-image positioning and recovery.

3. The headphone for sound-source compensation and sound-image positioning and recovery of claim 2, wherein the signal input device is a wired signal input device.

4. The headphone for sound-source compensation and sound-image positioning and recovery of claim 2, wherein the signal input device is a wireless signal input device.

5. The headphone for sound-source compensation and sound-image positioning and recovery of claim 1, further comprising a power device for supplying the headphone for sound-source compensation and sound-image positioning and recovery with required power.

6. The headphone for sound-source compensation and sound-image positioning and recovery of claim 5, wherein the power device is a battery.

7. The headphone for sound-source compensation and sound-image positioning and recovery of claim 1, further comprising a sound control device for adjusting timbre or volume of the headphone for sound-source compensation and sound-image positioning and recovery.

8. The headphone for sound-source compensation and sound-image positioning and recovery of claim 1, wherein the left speaker device comprises one of at least a first left speaker and at least a first right speaker.

9. The headphone for sound-source compensation and sound-image positioning and recovery of claim 1, wherein the right speaker device comprises one of at least a second left speaker and at least a second right speaker.

10. The headphone for sound-source compensation and sound-image positioning and recovery of claim 8, wherein right channel sound generated by the first right speaker is one of slightly later and slightly weaker than left channel sound generated by the first left speaker.

11. The headphone for sound-source compensation and sound-image positioning and recovery of claim 9, wherein left channel sound generated by the second left speaker is one of slightly later and slightly weaker than right channel sound generated by the second right speaker.
